(19) United States
(12) Patent Application Publication
(10) Pub. No.: US 2010/0100544 A1
(43) Pub. Date: Apr. 22, 2010

(54) DOCUMENT SEARCHING DEVICE, DOCUMENT SEARCHING METHOD, AND DOCUMENT SEARCHING PROGRAM

(75) Inventors: Jun Takeuchi, Tokushima-shi (JP); Takanori Hino, Tokushima-shi (JP); Shingo Ochi, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUST SYSTEMS CORPORATION, Tokushima-shi ,Tokushima (JP)

(21) Appl. No.: 12/442,835

(22) PCT Filed: Sep. 28, 2007
(86) PCT No.: PCT/JP2007/001065

§ 371 Date: Mar. 25, 2009

(30) Foreign Application Priority Data
Sep. 29, 2006 (JP) 2006-267888

(51) Int. Cl. G06F 17/30

(52) U.S. Cl. 707/736; 707/E17.033

(57) ABSTRACT

The present invention relates to a document retrieval apparatus for retrieving the desired data from a structured a document file. The apparatus holds index information in which a tag set including tags that are in a hierarchical relation with each other, is associated with one or more of positions of which path expressions include the tag set, in a structured document file. When receiving an input of a partial path expression, the apparatus specifies a position where the tag set included in the partial path expression is present as part of a path expression of the position, as a candidate position for a position to be retrieved, with reference to the index information.

### FIELD OF THE INVENTION

The present invention relates to a document processing technique, in particular, to an information retrieval technique in which a structured document file is handled.

### BACKGROUND ART

With the growing use of computers and the progress of the networking techniques, there has been an increase in electronic information exchange via network. In this background, a lot of paperwork that is conventionally paper-based has been replaced by network-based processing. The progress of the digitization and the networking technique has dramatically lowered the cost for information acquisition. Under these circumstances, there is an increasing importance of the technique in which desired data is retrieved from a lot of document files.

Patent Document 1: Japanese Patent Laid-Open No. 2006-048536

### DISCLOSURE OF THE INVENTION

### Problem to be Solved by the Invention

Recently, a number of document files have been created as structured document files described in HTML (Hyper Text Markup Language), XHTML (eXtensible HyperText Markup Language), or XML (eXtensible Markup Language) and the like. A structured document file is hierarchized by tags, hence the data included in the document can be designated by path notations of tags. Like this, a structured document file has the excellent characteristics that a position of data is easily specified. Among them, XML draws attention as a form suitable for sharing data with other persons via a network. When a document is described in XML, the data included in the document can be specified by an XPath (XML Path Language) expression that is a syntax based on XPath.

XPath is a notation system that can also handle ellipses. For example, the XPath expression of “/proposition//intensive processing” means a condition that the expression includes “all paths where the tag “intensive processing” is present in the lower hierarchy covered by the tag “proposition””. Hereinafter, such a condition with respect to a tag path is referred to as a “path condition”. In addition, a syntax that indicates a tag path based on a hierarchical tag structure like the XPath expression, is referred to as a “path expression”. Any path expression designated as “/proposition/intensive processing”, “/proposition/content/intensive processing”, and “/proposition/content/basic processing/intensive processing”, meets the above path condition. On the other hand, the XPath expression of “/proposition/*/intensive processing” means a path condition that the expression includes “all paths where the tag “intensive processing” is present in the hierarchy level that is 2-level lower than that of the tag “proposition””. Among the above three path expressions, “proposition/content/intensive processing” merely meets the path condition.

When a user can designate an XPath expression with no ellipse, the desired data can be taken out from a structured document file; however, path expressions are not always known accurately. For example, even when it is known that the data to be retrieved is included in the tag “intensive processing” covered by the tag “proposition”, there is sometimes the case where it is unknown what kind of tags and how many levels are present between the tag “proposition” and the tag “intensive processing”, or in the first place, which document the desired data is included in. When an incomplete path expression including an ellipse as stated above is inputted, it is convenient that the data meeting the path condition indicated by the path expression can be retrieved. Hereinafter, a path expression insufficient to specify a position of the data to be retrieved uniquely due to inclusion of an ellipse or the like, is referred to as a “partial path expression”, and a path expression including no ellipse is referred to as a “complete path expression”.

As a method for retrieving data based on the partial path expression, it is generally performed that the data present at a position meeting a path condition is detected after analyzing a tag structure of a structured document file and deploying the path information of tags on a memory. However, such method has problems that a large amount of memory is used and a processing time becomes long. In particular, when the desired data is retrieved from a lot of structured document files or from a structured document file of which hierarchical tag structure is complicated, these problems are likely to come to the surface.

In view of these circumstances, the present invention has been made, and a general purpose of the invention is to provide a technique in which the desired data can be efficiently retrieved from a structured document file based on an incomplete path expression.

### Means for Solving the Problem

An embodiment of the present invention relates to a document retrieval apparatus for retrieving the desired data from a structured document file. The apparatus holds index information in which a tag set including tags that are in a hierarchical relation with each other is associated with one or more positions of which path expressions include the tag set, in a structured document file. When receiving an input of a partial path expression, the apparatus specifies a position where the tag set included in the partial path expression is present as part of a path expression of the position, as a candidate position for a position to be retrieved, with reference to the index information.

By registering a position of each tag set as the index information, the data to be retrieved can be specified without a need of examining a hierarchical tag structure by accessing a document file upon executing retrieval. With this, even when an incomplete partial path expression is inputted, the data to be retrieved can be efficiently detected.

It is noted that any combination of the aforementioned components or any manifestation of the present invention realized by modification of a method, system, program, and recording medium and so forth, is effective as an embodiment of the present invention.

### ADVANTAGE OF THE INVENTION

According to the present invention, the desired data can be efficiently detected from a structured document file based on an incomplete path expression.

### BRIEF DESCRIPTION OF THE DRAWINGS

An Embodiment will now be described by way of example only, with reference to the accompanying drawings that are meant to be exemplary, not limiting, in which:

FIG. 1 is a schematic diagram illustrating an outline of the process executed by an document retrieval apparatus;

FIG. 2 is a diagram illustrating an XML document according to the present embodiment;

FIG. 3 is a diagram illustrating a data structure of a complete path index;

FIG. 4 is a diagram of a data structure illustrating a detail of the path column in FIG. 3;

FIG. 5 is a diagram illustrating a data structure of a partial path index;

FIG. 6 is a functional block diagram of the document retrieval apparatus;

FIG. 7 is a flow chart illustrating the process of the retrieval processing based on a partial path expression.

### REFERENCE NUMERALS

100 DOCUMENT RETRIEVAL APPARATUS
110 USER INTERFACE PROCESSOR
112 INPUT UNIT
114 DISPLAY UNIT
120 DATA PROCESSOR
122 PATH BREAKDOWN UNIT
124 RETRIEVAL UNIT
126 REGISTRATION UNIT
128 PARTIAL EXTRACTION UNIT
130 INDEX HOLDER
132 ID CONVERSION UNIT
134 POSITION SPECIFICATION UNIT
136 RANGE SPECIFICATION UNIT
200 DOCUMENT DATA BASE
212 DOCUMENT POSITION COLUMN
214 COMPLETE PATH INDEX
216 PATH COLUMN
218 PATH ID COLUMN
222 RANGE COLUMN
226 KEY COLUMN
228 POSITION INDEX COLUMN
230 PARTIAL PATH INDEX

### BEST MODE FOR CARRYING OUT THE INVENTION

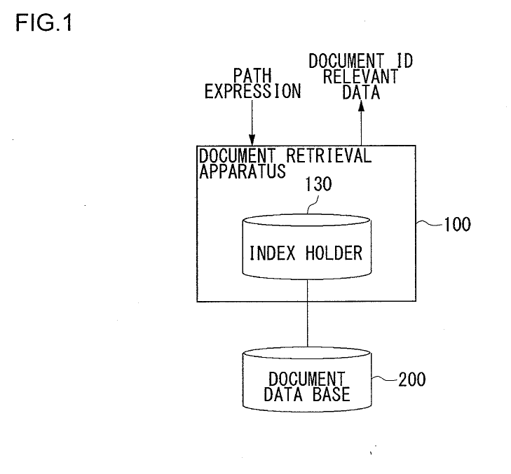

FIG. 1 is a schematic diagram illustrating an outline of the process executed by the document retrieval apparatus 100. When a user inputs a path expression in the document retrieval apparatus 100, the apparatus 100 retrieves the data meeting the path expression from a document data base 200. A document file in the document data base 200 is a structured document file structured by tags as is in an XML document and an XHTML document. In the present embodiment, a description will be made on the premise that a document file to be retrieved is an XML file.

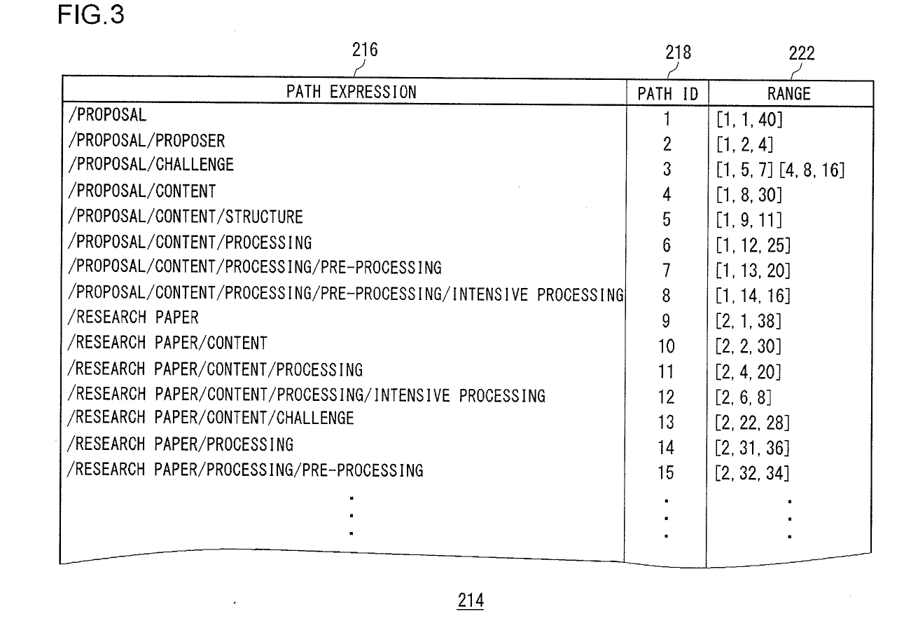

An index holder 130 in the document retrieval apparatus 100 holds index information for retrieving each document file. There are two types of the index information, complete path index 214 and partial path index 230, and each of them will be described in detail later with respect to FIGS. 3 to 5. The document retrieval apparatus 100 retrieves which position the data to be retrieved is present in a document from the document data base 200, based on the inputted path expression and the index information. The document retrieval apparatus 100 displays the document ID of the detected document file and the data to be retrieved in the document file, on the screen. In this way, a user of the document retrieval apparatus 100 finds out the data to be retrieved or a candidate for the data to be retrieved from the document data base 200, with respect to any path expression.

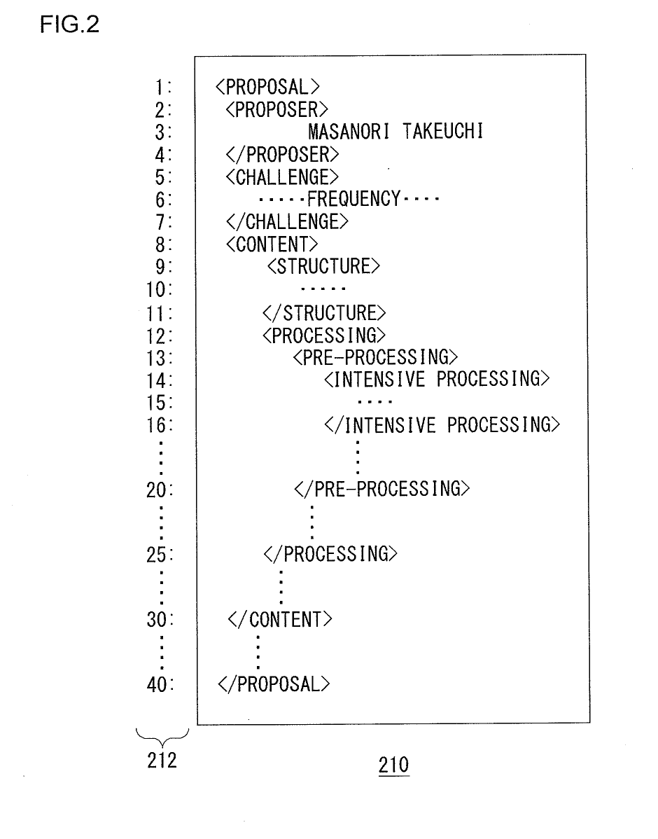

FIG. 2 is a diagram illustrating the XML document 210 according to the present embodiment. The present embodiment will be described below taking the XML document 210 illustrated in the diagram as an object to be processed. Each document file in the document data base 200 is provided with a document ID. It is assumed that a document ID of the XML document 210 illustrated in the diagram is “1”. A document ID is one for identifying a document file uniquely in the document data base 200. The XML document file 210 is an XML document with respect to an idea proposal, and includes a plurality of tags such as <proposition> and <proposer>. The document position column 212 indicates positions of various data included in the XML document file 210. For example, the document position of the tag <proposition> in this document is “1”, and that of the tag </intensive processing> is “16”. Further, the document position of the character string “Masanori Takeuchi”, which is the content data of the tag <proposer>, is “3”. A document position is assigned to each tag, attribute, comment, and the content data of a tag, and takes a unique value for each document. Hereinafter, an explanation will be made centering on the document positions with respect to tags, to make the explanation simple.

FIG. 3 is a diagram illustrating a data structure of the complete path index 214. The complete path index 214 is stored in the index holder 130. The path column 216 is a synopsis indicating path expressions included in the document data base 200. The path column 216 includes not only the path expressions included in the document with a document ID of 1 illustrated in FIG. 2, but also the path expressions included in other documents. The path ID column 218 indicates path IDs of paths indicated in the path column 216. The path ID is a numerical string obtained by converting a character string indicating a path expression according to a certain rule. The character string may be converted by a hash function or a certain table; and at any rate, the path ID may be a value with which each path expression can be uniquely identified to the extent where there is no practical difficulty in it.

In the diagram, the path ID of the path expression “/proposition” in the XML document 210 is “1”. In the case of the path expression “/proposition/proposer”, the path ID thereof=2 holds. Similarly, in the case of the path expression “/proposition/content/processing/pre-processing/intensive processing”, the path ID=8 holds.

The range column 222 indicates a range of the data indicated by a path expression in a form of [document ID, start position, end position]. In the case of the XML document 210 illustrated in FIG. 2, the document position of the tag <intensive processing> is “14” and that of the tag </intensive processing> is “16”; hence, the data of the tag </proposition/content/processing/pre-processing/intensive processing> is the data in the range of the document position=(14,16) in the document with a document ID of 1. Accordingly, the range data indicated by the range column 222 is [1,14,16].

Similarly, the range data indicated by the path expression “/research paper/content/challenge” is [2, 22, 28]. This means that the data in the range of the document position=(22,28) is specified by this path expression, in the document with a document ID of 2. The range data indicated by the path expression “/proposition/challenge” are two data items of [1,5,7] and [4,8,16]. This means that the path expression “/proposition/challenge” is included in both XML documents with document IDs of 1 and 4.

A node indicated as a path expression in the complete path expression 214 is not limited to a tag such as <proposer>. For example, the character string “Masanori Takeuchi”, which is the element data of the tag <proposer> in FIG. 2, can also be registered as a path expression. In the case, the followings hold: the path expression is “/proposition/proposer/“Masanori Takeuchi””; the path ID is 2014; and the range is [1,3,3]. The path ID of 2014 is a value obtained by converting the character string “/proposition/proposer/“Masanori Takeuchi”” by a certain rule.

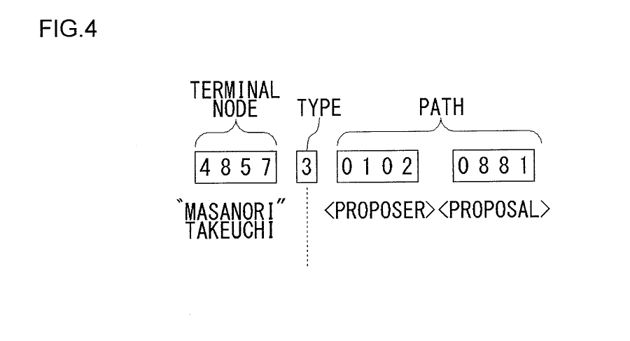

FIG. 4 is a diagram of a data structure illustrating a detail of the path column 216 in FIG. 3. In fact, the path column 216 stores the data numerically representing a path expression (hereinafter referred to as a “numerical path expression” when particularly distinguishing it) rather than storing a character string indicating a path expression, as it is. The numerical path expression indicates a path in a reverse manner to the real path.

An explanation will be made below taking the afore-mentioned path expression “/proposition/proposer/“Masanori Takeuchi”” as an example. In a numerical path expression, a 4-byte numerical value “4857” indicating the character string “Masanori Takeuchi”, which is a terminal node, is at first arranged at the forefront. “4857” is a numerical value obtained by converting the character string “Masanori Takeuchi” by a certain conversion rule. The following a 1-byte numerical value indicates the type of the terminal node. The type is any one of element: 1, attribute: 2, text: 3, PI (Processing Instruction): 7, and comment: 8. The character string “Masanori Takeuchi” is a text indicating the content of “/proposition/proposer”; hence, the type thereof is “3”. Subsequently, a 4-byte numerical value “0102” indicating <proposer> is arranged. “0102” is also obtained by converting the character string “proposer” by a certain conversion rule. A numerical value indicating <proposition> is “0881”. Each numerical value included in a numerical path expression may be a value with which a character string such as “proposition” or “Masanori Takeuchi”, which is a constituent of a path expression, can be identified uniquely. With this, the path expression “/proposition/proposer/“Masanori Takeuchi”” can be denoted as a 13-byte numerical path expression of “4857301020881” in the path column 216.

A: IN the Case where Complete Path Expression is Inputted

It is assumed that “/proposition/content/processing/pre-processing/intensive processing” is inputted as a complete path expression. The document retrieval apparatus 100 at first converts the complete path expression to a numerical path expression by the above method. The apparatus 100 then detects the path ID of 8 and the range data of [1,14,16] by comparing the numerical path expression to the numerical path expression in the path column 216 in the complete path index 214. The detection is made by matching the two numerical path expressions together; hence the retrieval processing can be performed at a higher speed than that performed by comparing two path expressions denoted by character strings together.

B: In the Case where Partial Path Expression is Inputted

It is assumed that “//structure” is inputted as a partial path expression. Because the complete path thereof is unknown, the document retrieval apparatus 100 converts the terminal node “structure” to a numerical representation. In the case, the document retrieval apparatus 100 detects the path ID of 5 and the range data of [1,9,11] by comparing the 4-byte numerical value indicating “structure” to the 4-byte numerical value at the forefront of a numerical path expression in the path column 216. In partial path expressions, there are many cases where the terminal nodes thereof are known while the higher nodes covering the terminal nodes are unknown. By arranging a numerical path expression so as to have a reverse order to that of the original path expression, candidates for the data to be retrieved can be narrowed down to some extent only with reference to the terminal node in a partial path expression

However, when partial path expressions such as “//content/processing/*/intensive processing”, “//content/processing//intensive processing”, and “//content/processing/*” are provided, an algorithm by which the data to be retrieved is specified from the complete path index 214 is complicated. As a tag hierarchy is deeper, the processing is more complicated. Therefore, in the present embodiment, the processing is performed in which the positions where the data to be retrieved is possibly present (hereinafter referred to as a “candidate position”) are efficiently narrowed down by the partial path index 230 in addition to the complete path index 214.

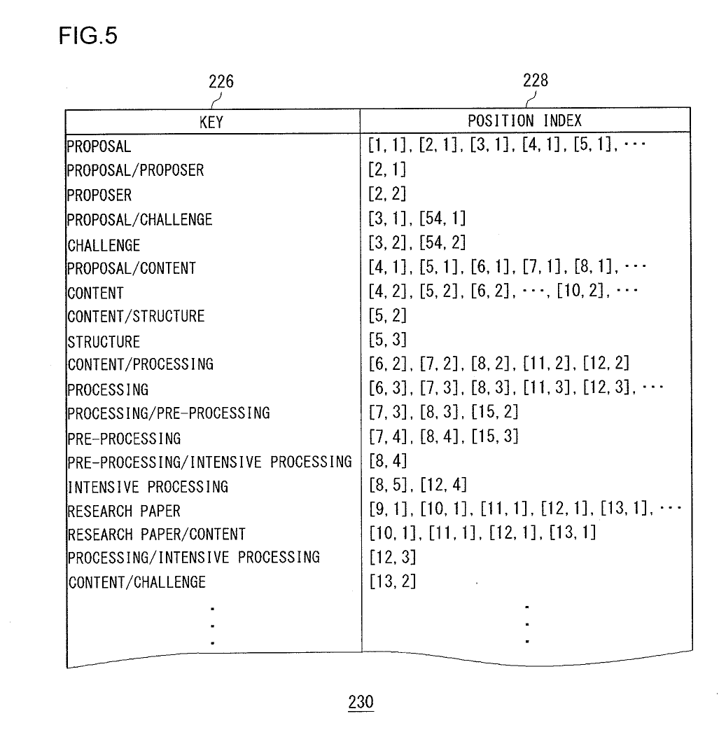

FIG. 5 is a diagram illustrating a data structure of the partial path index 230. The index holder 130 stores the partial path index 230 in addition to the complete path index 214. The key column 226 indicates two tags (hereinafter referred to as a “key tag set”) or one tag (hereinafter referred to as a “key tag”), which are keys for retrieval in the partial path index 230. When referring to the key tag set and the key tag in combination, they are simply referred to as a “key”. The key tag set indicates a combination of tags that are in a direct hierarchical relation with each other as a tag hierarchy in a document. For example, in the XML document 210, the direct parent tag of the tag <structure> is <content>, hence “content/structure” is a key tag set. While, the tag <proposition> and the tag <challenge> are not direct parent tags of the tag <structure>, hence “proposition/structure” and “challenge/structure” are not the key tag sets. On the other hand, all of the tags included in a document can be the key tags. The partial path index 230 indicates the data corresponding to the keys included in all documents included in the document data base 200.

The position index column 228 indicates a position where a key is present in a form of [path ID, hierarchy of presence]. The position data described in such a form is referred to as a “position index”. The key tag set “content/processing” is present in the path expression of “/proposition/content/processing” that is positioned in the second hierarchy level of the XML document 210 specified by a document ID of 1. In this case, the number of the hierarchy levels is counted on the premise that the root node is in 0 hierarchical level and the first level is present immediately below the root node. Hereinafter, it is intended that an XML document with a document ID of n (n is a natural number) is denoted as a document (ID: n). The information on a document ID is not present in the position index, hence it is unknown whether “content/processing” is present in a document (ID: n) only by the partial path expression 230.

Because the path ID of the path expression “/proposition/content/processing” is 6, the position index of “content/processing” is [6,2]. In a similar manner, the key tag set is present in the second hierarchical level of the path expression of “/proposition/content/processing/pre-processing” that is specified by the path ID of 7 in the document (ID: 1) . In the case, the position index of “content/processing” is [7,2].

In the case of the partial path expression of “//content/processing/*/intensive processing” stated above, the path condition indicated by the partial path expression is as follows:

1. “Content/processing” and “intensive processing” are included in the path expression.

2. Some sort of one hierarchical level is present between “content/processing” and “intensive processing”, in other words, “intensive processing” is present in the hierarchical level that is 3-level lower than that of <content>. At first, the tag set “content/processing” and the tag “intensive processing” are extracted from the partial path expression.

The position indexes of the key tag set “content/processing” are five of [6,2], [7,2], [8,2], [11,2], and [12,2]. That is, five candidates positions are specified as position indexes including the key tag set “content/processing” in their path expressions. Hereinafter, such a candidate position index is referred to as a “candidate position”. The position indexes of the key tag “intensive processing” are two of [8,5] and [12.4]. That is, there are two candidate positions with respect to the key tag “intensive processing”.

Herein, while the path expression ID is 6 with respect to the position index [6,2] of “content/processing”, there is no path ID of 6 with respect to the position index of the “intensive processing”. This means that the path expression with a path ID of 6 does not include “intensive processing”. In this way, the position index [6,2] is excluded from the above path condition. From the same reason, the position indexes of [7,2] and the [11,2] are excluded from the candidates. As a result, remained are the position indexes of [8,2], [12, 2] and [8,5], and [12,4].

A pair of [8,2] and [8,5] shows parts of the path expressions with a path ID of 8, and indicates that “content/processing” is present in the second hierarchical level and “intensive processing” is in the fifth level. That is, the path expression with a path ID of 8 includes the path expression of “/*/content/processing/*/intensive processing”, which is compatible with the path condition indicated by the partial path expression. The range data of [1,14,16] can be specified by referring to the data of the path ID of 8 in the complete path index 214. That is, the path expression of “proposition/content/processing/pre-processing/intensive processing” can be specified in the document (ID: 1).

On the other hand, a pair of [12,2] and [12,4] shows parts of the path expressions with a path ID of 12, and indicates that “content/processing” is present in the second hierarchical level and “intensive processing” is in the fourth level. That is, the path expression with a path ID of 12, “/*/content/processing/intensive processing”, is to be included; however, it is not compatible with the path condition indicated by the partial path expression. Accordingly, only the data in the range of the document position of (14,16) is the data to be retrieved in the document (ID: 1) .

In the same manner, when the partial retrieval formula of “//content/processing//intensive processing” is provided, the number of the hierarchical levels between “content/processing” and “intensive processing” is indeterminate; hence both path expressions with path IDs of 8 and 12 are candidates. When the partial path expression “//pre-processing//intensive processing” is provided, [7,4], [8,4], and [15,3] are candidates with respect to the tag “pre-processing”, and [8,5] and [12,4] are candidates with respect to the key tag “intensive processing”. By referring also to the complete path index 214, the path expression of which a document ID is 1 and of which path expression ID is 8, merely falls under the category. In the case of the partial retrieval formula of “//proposition/content/*/pre-processing/intensive processing”, the path expression of which path ID of 8 in the document (ID: 1) can be specified from the position index of the key tag set “proposition/content”, the position index of the key tag set “pre-processing/intensive processing”, and the complete path index 214. In this way, according to the partial path index 230, it is not necessary that, when an incomplete partial retrieval formula is inputted, path analysis with respect to an XML document per se in the document data base 200, is performed. Moreover, candidate positions can be narrowed down more efficiently than directly retrieving a path expression compatible with a path condition from the path column 216 in the complete path index 214. The retrieval using the partial path index 230 is particularly effective in the case where a tag hierarchy is deep or there are many documents to be retrieved.

A key in the key column 226 is stored as a numerical string with a certain length that is referred to as a key ID. The key ID may be a number with which a key tag set and a key can be identified uniquely. By storing the keys of numerically represented form in the key column 226, the retrieval processing can be performed at a higher speed than that of storing character strings indicating key titles as they are. The key ID may also be created by converting a character string indicating a key with a certain hash function. Alternatively, the keys and the key IDs may be associated with each other by a conversion table that associates both uniquely.

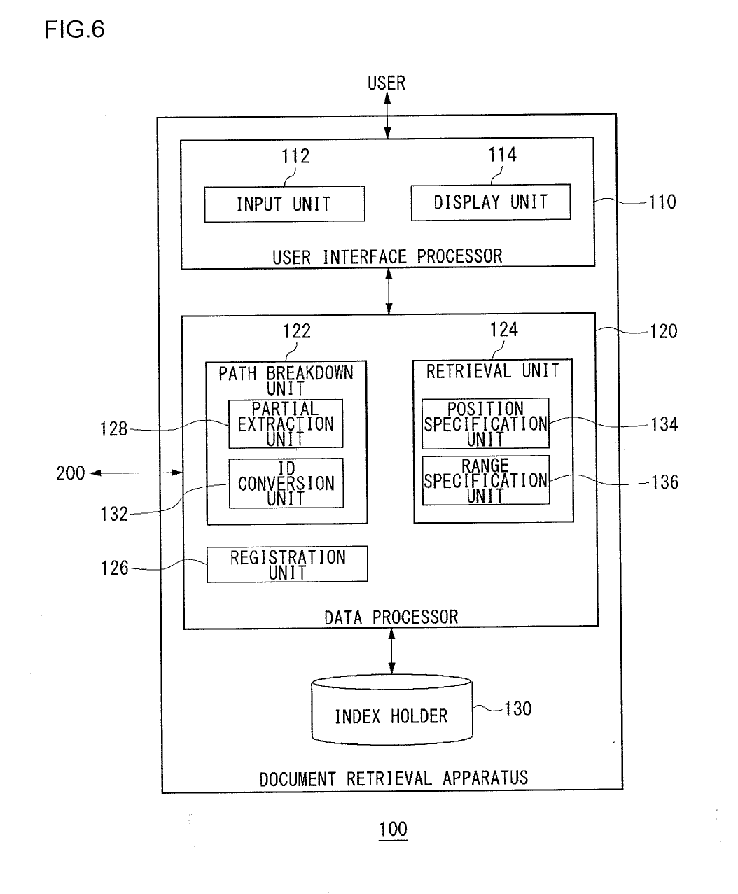

FIG. 6 is a functional block diagram of the document retrieval apparatus 100. Each block illustrated herein is implemented in hardware by any CPU of a computer, other elements, and mechanical devices, and implemented in software by a computer program or the like. FIG. 6 depicts functional blocks implemented by the cooperation of hardware and software. Therefore, it will be obvious to those skilled in the art that these functional blocks may be implemented in a variety of manners by a combination of hardware and software.

The document retrieval apparatus 100 comprises: a user interface processor 110; a data processor 120; and an index holder 130. The user interface processor 110 is in charge of processes with regard to a general user interface such as processing an input from a user and displaying information to the user. In the present embodiment, on the premise that a user interface service of the document retrieval apparatus 100 is provided by the user interface processor 110, a description will be made below. As another embodiment, a user may manipulate the document retrieval apparatus 100 via the Internet. In the case, a communication unit (not illustrated) receives manipulation-instruction information from a user terminal and transmits the information on a processing result executed based on the manipulation-instruction to the user terminal.

The data processor 120 executes various data processing based on the data acquired from the user interface processor 110 and the document data base 200. The data processor 120 also plays a role of an interface between the user interface processor 110 and the index holder 130.

The user interface processor 110 includes an input unit 112 and a display unit 114. The input unit 112 receives input manipulation from a user. A path expression for retrieval is acquired through the input unit 112. The display unit 114 displays various information to the user.

The data processor 120 includes a path breakdown unit 122, a retrieval unit 124, and a registration unit 126. The path breakdown unit 122 analyzes a partial path expression and the path information of an XML document. A partial extraction unit 128 extracts a tag or a tag set from a partial path expression and an XML document. An ID conversion unit 132 converts a path expression or a key to a numerical representation thereof, and also creates a path ID from a path expression. The registration unit 126 registers, when a new XML document is stored in the document data base 200, the data with respect to the document in the complete path index 214 and the partial path index 230.

When an XML document is stored in the document data base 200, the ID conversion unit 132 converts a path expression in the document to a numerical path expression, and the registration unit 126 registers the numerical path expression and the range data in the complete path index 214. The partial extraction unit 128 extracts a key from a document, and the ID conversion unit 132 converts the key to a key ID of a numerically represented form. The registration unit 126 registers the key ID of a numerically represented form and a position index in the partial path index 230. When an XML document stored in the document data base 200 has been edited or deleted, the complete path index 214 and the partial path index 230 are updated in the same processing manner.

The retrieval unit 124 detects a document and a relevant section thereof based on the inputted path expression. The retrieval unit 124 includes a position specification unit 134 and a range specification unit 136. The position specification unit 134 specifies a position index from a key with reference to the partial path index 230. The range specification init 136 specifies the range data from a path expression. Upon the retrieval with the use of a partial path expression, the partial extraction unit 128 extracts a key from the partial path expression, and the ID conversion unit 132 converts the key to a key ID of a numerically represented form. The position specification unit 134 specifies a candidate position from the partial path index 230 based on the key ID. The range specification unit 136 specifies the range data from the candidate position specified by the position specification unit 134. The results thereof are displayed on the screen by the display unit 114.

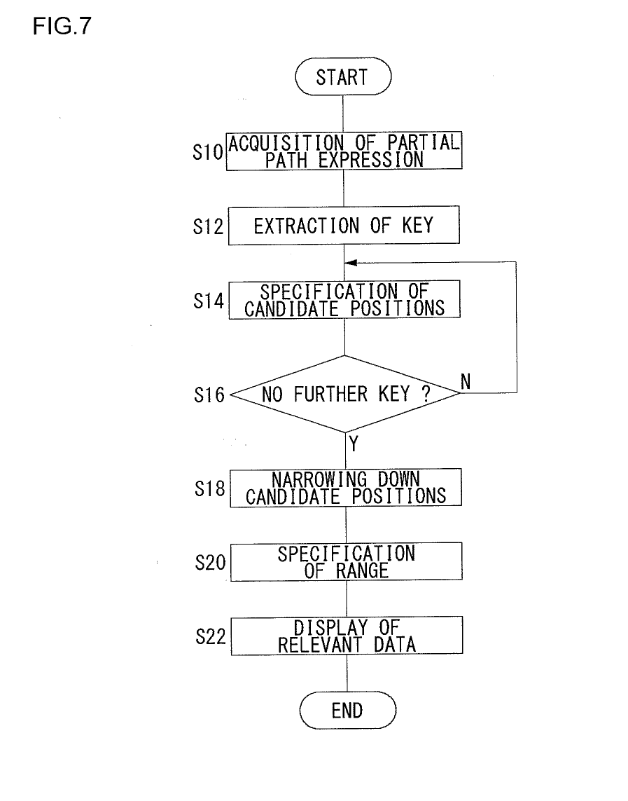

FIG. 7 is a flow chart illustrating the process of the retrieval processing based on a partial path expression. The input unit 112 at first receives an input of a partial path expression (S10). The partial extraction unit 128 extracts one or more of tag sets or tags, which are the keys for retrieval, from the partial retrieval expression (S12). Herein, it is assumed that the previous partial retrieval expression “//content/processing/*/intensive processing” is inputted, and the key tag set “content/processing” and the key tag “intensive processing” are extracted. The extracted keys are converted to the key IDs by the ID conversion unit 132. The position specification unit 134 specifies a candidate position from the key IDs with reference to the partial path index 230 (S14). For the position indexes for the key tag set “content/processing”, the following five position indexes: [6,2], [7,2], [8,2], [11,2], and [12,2], are specified.

When another key is further extracted (S16/N), the flow returns to S14 so that a candidate position with respect to the next key is specified. In the case of the previous example, 2 position indexes of [8,5] and [12,4] are specified with respect to the key tag “intensive processing.”

When candidate positions have been specified with respect to all keys (S16/Y), the position specification unit 134 specifies a position that is compatible among the specified candidate positions, with respect to each key (S18). In this manner, the number of candidate positions is narrowed down. With respect to the partial retrieval expression “//content/processing/*/intensive processing”, a pair of [8,2] and [8,5] are specified. The range specification unit 136 specifies the range data [1,14,16] from the complete path index 214, based on the path ID of 8 indicated by the position index (S20). With respect to the path expression of the path ID of 8 in the document (ID: 1), the display unit 114 displays on the screen the relevant data, that is, the data in the range of the document positions 14 to 16 (S22).

Based on the afore-mentioned algorithm, more multiple data retrieval can be performed. For example, it is assumed that the partial retrieval expression “//proposer” and the character string “Masanori Takeuchi” are inputted. The position specification unit 134 specifies the position index [2,2] from the partial path index 230 with respect to the key tag “proposer”. According to the complete path index 214, the range data relevant to “//proposer” is present in the document position (2,4) in the document (ID: 1) . The path expression thereof is “/proposition/proposer”.

With respect to the character string “Masanori Takeuchi”, a character string retrieval unit (not illustrated) in the retrieval unit 124 retrieves the range data relevant thereto from the complete path index 214. It is assumed that [1,3,3] is specified as the range data. In the case, the range of the data of the character string “Masanori Takeuchi” falls within the range of the data of “proposition/poposer”. Because the range data specified with respect to each of the partial path expression “//proposer” and the character string “Masanori Takeuchi” are compatible, the retrieval unit 124 specifies “/proposition/proposer/“Masanori Takeuchi”” as relevant data.

The description has been made on the premise that the tag set according to the present embodiment is a combination of two tags that are in a direct hierarchical relation with each other. However, a tag set is not necessary to be limited to such a condition. For example, a combination of three tags that are in a direct hierarchical relation together is possible. Of course, a combination of three or more of tags is also possible as a key tag set.

The tags included in a key tag set are not always required to be in a direct hierarchical relation. For example, in the path expression of “proposition/content/processing/pre-processing/intensive processing”, a combination of tags of “content-pre-processing”, has a two-level difference between the two tags. A combination of tags of “content-intensive processing”, has a three-level difference between the two tags. In the partial path index 230, key tag sets and level-differences between the tags included in the tag set, may be stored. And, the position specification unit 134 may specify a candidate position with reference to the level-differences between a tag set and between a key tag set which are extracted from a partial path expression.

In the present embodiment, the description has been made with an XML document targeted; however, the document retrieval apparatus 100 is applicable to document files described in any one of XHTML, HTML, SGML and so forth in which a position of data can be specified by a path expression based on a hierarchical structure of tags.

According to the document retrieval apparatus 100 illustrated in the present embodiment, data retrieval based on a partial path expression can be performed efficiently. By registering position indexes with respect to “key tags” and “key tag sets” in the partial path index 230, a candidate position for the retrieval can be narrowed down based on the tag sets and tags included in the partial path expression. In addition, a position of the data can be specified more specifically by the complete path index 214. Retrieval can be performed efficiently because it is not necessary to check a document file upon retrieving and to deploy path information on the memory.

When a processing burden in data retrieval performed by a partial path expression is large, the data retrieval based on the partial path expression is difficult to be used by a user. The document retrieval apparatus 100 shown in the present embodiment can specify a position of the data to be retrieved at a higher speed and with a light burden for computers, by referring to two types of index data, the complete path index 214 and the partial path index 230.

Described above is the explanation of the present invention based on an embodiment. The embodiment is intended to be illustrative only and it will be obvious to those skilled in the art that various modifications to constituting elements and processes could be developed and that such modifications are also within the scope of the present invention.

The “index information” described in the claims is represented by the partial path index 230 in the present embodiment. The “tag set ID” described in the claims is represented as a key ID with respect to a key tag set in the present embodiment. It will be obvious to those skilled in the art that the function to be achieved by each constituent requirement described in the claims may be achieved by each functional block shown in the exemplary embodiment or by a combination of the functional blocks.

### INDUSTRIAL APPLICABILITY

According to the present invention, the desired data can be efficiently retrieved from a structured document file based on an incomplete path expression.

1. A document retrieval apparatus comprising:
an index holder that holds index information in which a tag set, which is a combination of tags that are in a hierarchical relation with each other, is associated with one or more of positions of which path expressions include the tag set, in a structured document file in which a position of data is specified by a path expression based on a hierarchical structure of tags;
a path expression input unit that receives an input of a partial path expression representing part of an path expression for a position to be retrieved in the structured document file;
a tag set extraction unit that extracts a tag set of which tags are in a hierarchical relation with each other from the partial path expression; and
a candidate position specification unit that specifies a position where the tag set extracted from the partial path expression is present as part of the path expression of the position, as a candidate position for the position to be retrieved, with reference to the index information.

2. The document retrieval apparatus according to claim 1, wherein the tag set is a combination of two tags that are in a direct hierarchical relation with each other.

3. The document retrieval apparatus according to claim 1, wherein, when the tag set extraction unit extracts a first tag set and a second tag set from the partial path expression, the candidate position specification unit specifies a position where a candidate position with respect to the first tag set and a candidate position with respect to the second tag set are compatible when both candidate positions are compared, as a candidate position for the position to be retrieved.

4. The document retrieval apparatus according to claim 3, wherein, when the tag set extraction unit detects the first tag set as a higher tag set than the second tag set in a hierarchical relation, the candidate position specification unit specifies a position where a hierarchical distance between the first tag set and the second tag set in the partial path expression, and a distance between the candidate position with respect to the first tag set and the candidate position with respect to the second tag set, are compatible, as a candidate position for the position to be retrieved.

5. The document retrieval apparatus according to claim 1, wherein the index holder further holds a tag included in the structured document file and one or more positions of which path expressions include the tag, with the tag and the positions being associated with each other as part of the index information, and wherein the tag set extraction unit extracts a certain tag from the partial path expression, and wherein the candidate position specification unit not only detects a position where the certain tag extracted from the partial path expression is present as part of a path expression for the position as a candidate position for the certain tag, but also specifies a position where the candidate position for the tag set extracted from the partial path expression and the candidate position for the certain tag are compatible, when both positions are compared, as a candidate position for the position to be retrieved, with reference to the index information.

6. The document retrieval apparatus according to claim 1, wherein the index holder holds a tag set ID, which is converted from a tag set so as to have a certain length of character strings in accordance with a predetermined rule, and one or more of positions of which path expressions include the tag set, with the tag set ID and the positions being associated with each other as the index information, and wherein the candidate position specification unit specifies a candidate position after converting a tag set extracted from the partial path expression to a tag set ID in accordance with the predetermined rule.

7. A method for retrieving a document comprising:
acquiring index information in which a tag set, which is a combination of tags that are in a hierarchical relation with each other, is associated with one or more of positions of which path expressions include the tag set, in a structured document file in which a position of data is specified by a path expression based on a hierarchical structure of tags;
receiving an input of a partial path expression demonstrating part of an path expression for a position to be retrieved in the structured document file;
extracting a tag sets of which tags are in a hierarchical relation with each other from the partial path expression; and
specifying a position where the tag set extracted from the partial path expression is present as part of the path expression of the position, as a candidate position for the position to be retrieved, with reference to the index information.

8. A document retrieval computer program product comprising:
a module that holds index information in which a tag set, which is a combination of tags that are in a hierarchical relation with each other, is associated with one or more of positions of which path expressions include the tag set, in a structured document file in which a position of data is specified by a path expression based on a hierarchical structure of tags;
a module that receives an input of a partial path expression demonstrating part of an path expression for a position to be retrieved in the structured document file;
a module that extracts a tag set of which tags are in a hierarchical relation with each other from the partial path expression; and
a module that specifies a position where the tag set extracted from the partial path expression is present as part of the path expression of the position, as a candidate position for the position to be retrieved, with reference to the index information.
